(19) United States
(12) Patent Application Publication
(10) Pub. No.: US 2026/0233403 A1
(43) Pub. Date: Aug. 13, 2026

(54) PARAMETER JOINT CALIBRATION METHOD AND SYSTEM FOR MOBILE ROBOT, DEVICE, AND STORAGE MEDIUM

(71) Applicant: SHANGHAI SEER INTELLIGENT TECHNOLOGY CORPORATION, Shanghai (CN)

(72) Inventors: Jiang YI, Shanghai (CN); Weike WANG, Shanghai (CN)

(73) Assignee: SHANGHAI SEER INTELLIGENT TECHNOLOGY CORPORATION, Shanghai (CN)

(21) Appl. No.: 19/523,966

(22) PCT Filed: Nov. 30, 2023
(86) PCT No.: PCT/CN2023/135564

§ 371 Date: Mar. 27, 2026

(30) Foreign Application Priority Data
Mar. 29, 2023 (CN) 202310317609.0

(51) Int. Cl. B25J 9/16; B25J 5/00

(52) U.S. Cl. CPC B25J 9/1692; B25J 5/007; B25J 9/1664

(57) ABSTRACT

The present disclosure provides a joint parameter calibration method and system for a mobile robot, a device, and a storage medium. The method includes the following steps: step S100, causing the mobile robot to travel along a path passing through all modes, and correspondingly recording positioning trajectory data of a positioning sensor and data of a motor encoder; step S200, deducing ideal trajectory information of the mobile robot by the data of the motor encoder in combination with a kinematic model of the mobile robot; and step S300, converting the positioning trajectory data into trajectory information of the mobile robot according to a mounting position of the positioning sensor, and then performing least squares problem solving after performing differential alignment with the ideal trajectory information to acquire calibrated kinematic parameters of the mobile robot and mounting parameters of the positioning sensor, thereby realizing automatic calibration in one step.

### BACKGROUND OF THE INVENTION

### 1. Technical Field

The present disclosure relates to the mobile robot navigation technology, and in particular to, a method and system for joint calibration of kinematic and positioning sensor parameters of a mobile robot based on laser odometer, a device, and a storage medium.

### 2. Description of Related Art

After a mobile robot with a sensor positioning device is assembled, since the production and mounting processes of the moving components of the robot chassis are not absolutely precise, kinematic errors of the robot will be introduced, for example, the nominal size of the wheel radius is inconsistent with the actual size; there is a deviation between the designed mounting position and the actual mounting position of the wheels; and there is a certain offset in the zero position of the steering angle, and the like.

As the basis for the robot to perceive the surrounding environment, the positioning sensor needs to determine its own position according to the surrounding information, and then calculate the position of the robot through the relative mounting position of the positioning sensor with respect to the robot coordinate center. However, mounting errors of the positioning sensor are inevitably introduced in the actual mounting process.

Kinematic errors of the mobile robot directly affect the accuracy of trajectory tracking. Mounting errors of positioning sensors (including, for example, laser odometers, lidars, cameras, GNSS, and other devices for calculating positioning) prevent the robot from accurately determining its position, thereby introducing systematic deviations relative to the actual positions of the robot. Therefore, calibrating the kinematic parameters of the robot and the parameters of the positioning sensor is an important method to improve the motion accuracy of the robot.

Currently, “Sensor and chassis joint calibration system and method for mobile robot” has been disclosed in the prior art (Chinese Patent Publication No. CN114442054A). Position information of the start and end points are collected after the robot is repeatedly controlled to move a corresponding linear distance or rotate by a corresponding angle, and then the calibration matrix is obtained according to the matrix transformation relationship between the odometer information within the linear distance and the positioning information of the sensor.

However, this solution needs manual control, and information collected therein is pose data before and after a certain mode (such as move linearly or turn) of the robot. Therefore, it requires multiple calibrations, and each calibration only calculates information of a part of parameters to be calibrated.

In another aspect, “calibration method and apparatus for motion model of two wheeled differential drive robot, and odometer system” has been proposed in the prior art (Chinese Patent Publication No. CN109571467B), which records parameter calibration of the kinematic model of the two wheeled differential drive vehicle. After performing multiple movements in different modes, the start and end position information of each movement mode is collected. The ideal position of the vehicle is estimated according to the encoder information and the kinematic model, and then compared with the actual position. The kinematic parameters of the two wheeled differential drive vehicle are obtained by using a generalized inverse matrix.

However, in this solution, only the two-wheeled differential drive vehicle is calibrated, and the mounting error information of the positioning sensor is not calibrated. Moreover, the calibration data is only calculated according to the pose error at the end point of the vehicle without considering the error information between the vehicle and its trajectory during operation.

Further, “calibration method and device for parameters of mobile robot, and storage medium” has been proposed in the prior art (Chinese Patent Publication No. CN115272476A), which records that a camera device is used to take pictures at a plurality of navigation marks in an operation environment of the robot to obtain actual pose data, and the calibration parameters are solved based on a least squares algorithm according to a conversion relationship between the actual pose data and standard pose data with respect to the calibration parameters, so as to calculate motion parameters of the robot. There are still some solutions need manual control of the movement of the robot to manually adjust the parameters until a certain error range is satisfied.

However, in this solution, the actual pose is calculated based on the camera device. Information of some preset points is only considered in the operation of the robot. Therefore, the convergence efficiency is not high, and the mounting error of the camera device is not calibrated.

It can be seen that in current solutions related to parameter calibration of mobile robots, in some solutions, the robot needs to be manually controlled for kinematic parameter calibration. In some other solutions, the mounting error parameters of the positioning sensor cannot be calibrated at the same time.

### BRIEF SUMMARY OF THE INVENTION

Therefore, a main objective of the present disclosure is to provide a joint parameter calibration method and system for a mobile robot, a device, and a storage medium to achieve primary automatic calibration and calibrate mounting parameters of the positioning sensor while calibrating the kinematic parameters of the robot.

To achieve the above objective, according to a first aspect of the present disclosure, provided is a joint parameter calibration method for a mobile robot, including the following steps:
step S100, causing the mobile robot to travel along a path passing through all modes, and correspondingly recording positioning trajectory data of a positioning sensor and data of a motor encoder;
step S200, deducing ideal trajectory information of the mobile robot by the data of the motor encoder in combination with a kinematic model of the mobile robot; and
step S300, converting the positioning trajectory data into trajectory information of the mobile robot according to a mounting position of the positioning sensor, and then performing least squares problem solving after performing differential alignment with the ideal trajectory information to acquire calibrated kinematic parameters of the mobile robot and mounting parameters of the positioning sensor, thereby realizing automatic calibration in one step, where the kinematic parameters of the robot and the mounting parameters of the positioning sensor are calibrated simultaneously.

In a possible preferred implementation, in step S200, calculation steps of the ideal trajectory information comprise: calculating:

$$Δ {t}_{c i} = K Δ {b}_{i}$$

where Δt_{ci} is a pose change of the mobile robot at each moment; K is a kinematic model of the mobile robot; Δbᵢ is a distance traveled by each execution component of the mobile robot at a moment i; and
then, calculating the ideal trajectory information by accumulating initial pose data and Δt_{ci}.

In a possible preferred implementation, when the mobile robot is of a dual steering wheel structure, a steering wheel motor is defined such that the steering motor and the traveling motor are coaxially mounted, and the calculation steps of the ideal trajectory information includes:

$$letting Δ {b}_{i} = {[ Δ {x}_{1 i} , Δ {y}_{1 i} , Δ {x}_{2 i} , Δ {y}_{2 i} ]}^{T} ,$$

$$= [ \begin{matrix}1 & 0 & - {y}_{1} \\ 0 & 1 & {x}_{1} \\ 1 & 0 & - {y}_{2} \\ 0 & 1 & {x}_{2}\end{matrix} ]$$

$$K = {( {A}^{T} A )}^{- 1} {A}^{T}$$

where Δx₁ᵢ, Δy₁ᵢ, Δx₂ᵢ,Δy₂ᵢ are position changes of the first steering wheel motor and the second steering wheel motor in the x-axis direction and the y-axis direction at the moment i, x₁ and y₁, and x₂ and Y₂ are x-axis coordinates and y-axis coordinates of the first steering wheel motor and the second steering wheel motor under the coordinate system of the robot, T is transpose, and A is a kinematic characteristic matrix of the mobile robot in a non-overconstrained state.

In a possible preferred implementation, when the mobile robot is of a single steering wheel structure, a steering wheel motor is defined such that the steering motor and the traveling motor are coaxially mounted, and the calculation steps of the ideal trajectory information includes:

$$letting Δ {b}_{i} = {[ Δ {x}_{1 i} , Δ {y}_{1 i} ]}^{T} ,$$

$$K = [ \begin{matrix}1 & 0 \\ 0 & 1 \\ 0 & \frac{1}{{x}_{1}}\end{matrix} ]$$

where Δx₁i,Δy₁i is a position change of the first steering wheel motor in x and y-axis directions at the moment i, x₁ is an x-axis coordinate of the first steering wheel motor under the coordinate system of the robot, and T is a transpose.

In a possible preferred implementation, when the mobile robot is of a dual differential drive wheel structure, a differential wheel motor is defined as a traveling motor, and the calculation steps of the ideal trajectory information includes:

$$letting Δ {b}_{i} = {[ Δ {x}_{1 i} , Δ {x}_{2 i} ]}^{T} ,$$

$$K = [ \begin{matrix}\frac{1}{2} cos ( {α}_{ci} ) & \frac{1}{2} cos ( {α}_{ci} ) \\ \frac{1}{2} sin ( {α}_{ci} ) & \frac{1}{2} sin ( {α}_{ci} ) \\ - \frac{1}{( {y}_{1} - {y}_{2} )} & \frac{1}{( {y}_{1} - {y}_{2} )}\end{matrix} ]$$

where Δx₁ᵢ, Δx₂ᵢ are position changes of the first traveling motor and the second traveling motor in the x-axis direction at the moment i, y₁ and Y₂ are respectively y-axis coordinates of the first traveling motor and the second traveling motor under the coordinate system of the robot, α_{ci} is a heading angle of the mobile robot at the moment i, α_{ci+1}=a_{ci}+Δα_{ci}, 1≤i≤n, α_{c1} is a heading angle of the robot at an initial moment, and T is a transpose.

In a possible preferred implementation, in step S300, the least-squares problem is as follows:

$$f = {\sum }_{i = 1}^{N - ndiff} {( \hat{d} {t}_{ci} - {dt}_{ci} )}^{T} ( \hat{d} {t}_{ci} - {dt}_{ci} )$$

where N-ndiff represents the number of data points after differential alignment, a value thereof is a difference between the number N of trajectory points and a differential interval ndiff, \hat{d}t_{ci} is an ideal trajectory positioning position at the moment i after differential alignment, dt_{ci} is a trajectory positioning position of the mobile robot after differential alignment, and T is a transpose; and through an iterative calculation, a parameter with a minimum cost function value is taken as the calibrated kinematic parameter of the mobile robot and the mounting parameter of the positioning sensor.

To achieve the above objective, according to a second aspect of the present disclosure, further provided is a joint parameter calibration system for a mobile robot, including:
a storage unit, configured to store a program comprising steps of the joint parameter calibration method for a mobile robot according to any one of the above for a control unit and a processing unit to timely retrieve and execute;
the control unit, configured to control the mobile robot to travel along a path passing through all modes, correspondingly record positioning trajectory data of a positioning sensor and data of a motor encoder, and send the same to the processing unit; and
the processing unit, configured to deduce ideal trajectory information of the mobile robot by the data of the motor encoder in combination with a kinematic model of the mobile robot; and convert the positioning trajectory data into trajectory information of the mobile robot according to a mounting position of the positioning sensor, and then perform least squares problem solving after performing differential alignment with the ideal trajectory information to acquire calibrated kinematic parameters of the mobile robot and mounting parameters of the positioning sensor, thereby acquiring the calibrated kinematic parameters of the mobile robot and the mounting parameters of the positioning sensor.

To achieve the above objective, according to a third aspect of the present disclosure, further provided is a computer device, including a memory and a processor. The memory stores a computer program, where when executing the computer program, the processor implements the steps of the method according to any one of the above.

To achieve the above objective, according to a fourth aspect of the present disclosure, further provided is a computer-readable storage medium, storing a computer program, where when executed by a processor, the computer program implements the steps of the method according to any one of the above.

Through the joint parameter calibration method and system for a mobile robot, the device, and the storage medium provided by the present disclosure, aiming at the errors in the manufacturing and mounting processes of kinematic components of the mobile robot, the kinematic and sensor parameters are calibrated at the same time based on the least squares method, thereby improving the operating precision of the robot.

In addition, by causing the mobile robot to automatically travel along a predesigned path that includes all motion modes of the robot in one run and recording the positioning information of the positioning sensor and the information of the motor encoder, the required parameter calibration may be completed in a single operation. In addition, the differential alignment operation on the actual positioning information and the ideal positioning information may effectively utilize information of kinematic characteristics in the operating process of the robot, thereby improving the convergence efficiency during parameter calculation.

### BRIEF DESCRIPTION OF THE SEVERAL VIEWS OF THE DRAWINGS

The accompanying drawings, which form a part of the present application, are provided to offer a further understanding of the present disclosure. The exemplary embodiments of the present disclosure and the descriptions thereof are used to explain the present disclosure, and do not constitute an improper limitation to the present disclosure. In the figures:

FIG. 1 is a schematic diagram illustrating steps of a joint parameter calibration method for a mobile robot according to the present disclosure.

FIG. 2 is a schematic diagram of a processing logic of a joint parameter calibration method for a mobile robot according to the present disclosure.

FIG. 3 is a schematic diagram of dual steering wheel structure definition in a joint parameter calibration method for a mobile robot according to the present disclosure.

FIG. 4 is a schematic diagram of single steering wheel structure definition in a joint parameter calibration method for a mobile robot according to the present disclosure.

FIG. 5 is a schematic diagram of differential wheel structure definition in a joint parameter calibration method for a mobile robot according to the present disclosure.

FIG. 6 is a schematic diagram of an actual movement trajectory of a mobile robot corresponding to a path in FIG. 7 in a joint parameter calibration method for a mobile robot according to the present disclosure.

FIG. 7 is a schematic diagram of a Θ-shaped path defined in a joint parameter calibration method for a mobile robot according to the present disclosure.

FIG. 8 is a schematic diagram of substituting calibration parameters into an offline odometer and comparing the same with a real trajectory in a joint parameter calibration method for a mobile robot according to the present disclosure.

FIG. 9 is a schematic diagram of substituting calibration parameters into an offline odometer and differentially aligning the same with a real trajectory in a joint parameter calibration method for a mobile robot according to the present disclosure.

FIG. 10 is a schematic diagram of a single steering wheel cart required to travel along a three-parallel-line path in a joint parameter calibration method for a mobile robot according to the present disclosure.

FIG. 11 is a schematic diagram of a trajectory after the single steering wheel cart is actually required to travel along a three-parallel-line path in a joint parameter calibration method for a mobile robot according to the present disclosure.

FIG. 12 is a schematic diagram of requiring a single steering wheel cart to substitute calibration parameters into an offline odometer and differentially aligning the same with a real trajectory in a joint parameter calibration method for a mobile robot according to the present disclosure.

FIG. 13 is a schematic diagram of requiring a dual differential wheel cart to substitute calibration parameters into an offline odometer and comparing the same with a real trajectory in a joint parameter calibration method for a mobile robot according to the present disclosure.

FIG. 14 is a schematic diagram of requiring a dual differential wheel cart to substitute calibration parameters into an offline odometer and differentially aligning the same with a real trajectory in a joint parameter calibration method for a mobile robot according to the present disclosure.

FIG. 15 is a schematic structural diagram of a joint parameter calibration method for a mobile robot according to the present disclosure.

### DESCRIPTION OF REFERENCE NUMERALS

1, first steering wheel motor; 2, second steering wheel motor; a, first traveling motor; b, second traveling motor; a1, first steering motor; b1, second steering motor; c, positioning laser; d, driven wheel.

### DETAILED DESCRIPTION OF THE INVENTION

To allow those skilled in the art to gain a better understanding of the technical solutions of the present invention, the present invention is clearly and completely described below in conjunction with embodiments to help those skilled in the art further understand of the present invention. Obviously, the embodiments described below are merely illustrative ones rather than all possible ones of the present invention. It should be noted that for those ordinarily skilled in the art, the embodiments in the application and the features in the embodiments may be combined without departing from the concept of the present invention and causing conflicts. All other embodiments obtained by those ordinarily skilled in the art on the basis of the following ones without creative labor should also fall within the disclosure and protection scope of the present invention.

In addition, terms such that “first”, “second”, “S1” and “S2” in the specification, claims and drawings of the present invention are used for distinguishing similar objects and do not describe a specific sequence or precedence order. It should be understood that data defined by these terms may be exchanged in appropriate cases to allow the embodiments of the present invention described here to be implemented in other sequences other than those described here. In addition, terms “comprise” and “include” and any variants thereof in the present invention are intended to indicate non-exclusive inclusion. Unless otherwise expressly stated and defined, terms “arrange”, “dispose”, “mount”, “link” and “connect” should be understood in a broad sense. For example, “connect” may refer to fixed connection, detachable connection or integrated connection; mechanical connection or electrical connection; direct connection, indirect connection by means of an intermediate medium, or internal communication of two elements. Those ordinarily skilled in the art may appreciate the specific meanings of these terms in the present invention according to specific circumstances in conjunction with the prior art.

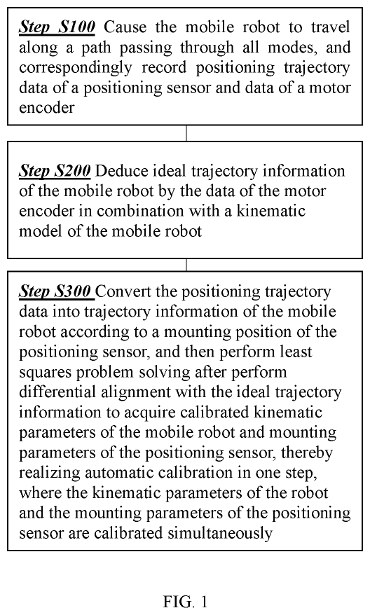

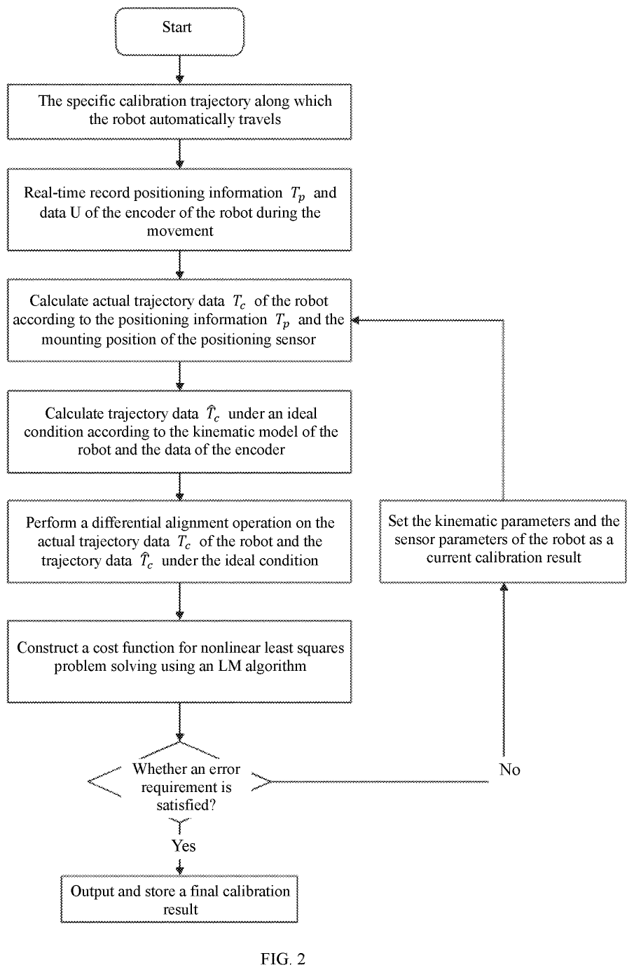

Referring to FIGS. 1-14, to achieve primary automatic calibration and calibrate mounting parameters of the positioning sensor while calibrating the kinematic parameters of the robot, a first embodiment of the present disclosure provides a joint parameter calibration method for a mobile robot, including the following steps:

step S100, the mobile robot is caused to travel along a path passing through all modes, and trajectory data of a positioning sensor and data of a motor encoder are correspondingly recording positioned.

Specifically, the motion mode path refers to a motion state composed of behaviors such as forward movement, backward movement, left turn, straight movement, and right turn of the robot, for example, straight forward movement and left turn during backward movement. In this case, the position information tₚᵢ=[xₚᵢ, yₚᵢ, αₚᵢ]^{T} of the positioning sensor and the data information μᵢ=[w₁ᵢ, w₂ᵢ, . . . , wₖᵢs₁ᵢ,s₂ᵢ, . . . , sₗᵢ]^{T} of the motor encoder may be recorded in real time during operation of the robot.

tₚᵢ represents a positioning trajectory of the positioning sensor at a moment i, and xₚᵢ, yₚᵢ, aₚᵢ respectively represent an abscissa, an ordinate and a heading angle of the positioning trajectory at the moment i. μᵢ represents data read from the encoder at the moment i, wₖᵢ represents encoder data of an kth traveling motor (i.e., a motor that controls the robot to travel) at the moment i, the subscript k represents the number of the traveling motors, s_{Ii} represents encoder data of an I^{th} steering motor (i.e., a motor that controls the robot to steer) at the moment i, and the subscript I represents the number of the steering motors.

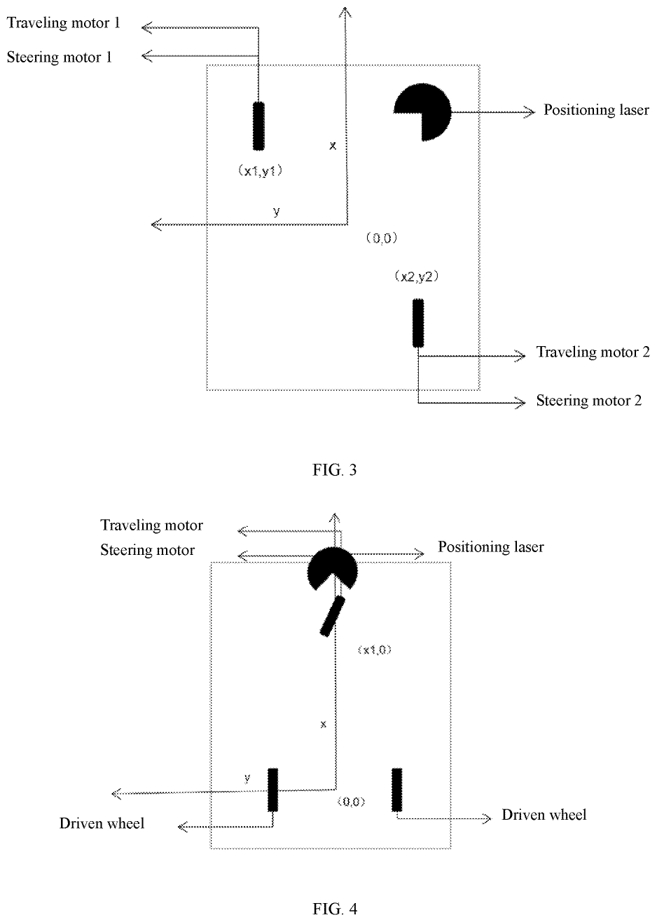

With respect to the dual steering wheel mobile robot shown in FIG. 3, k=I=2.

With respect to the single steering wheel mobile robot shown in FIG. 4, k=I=1.

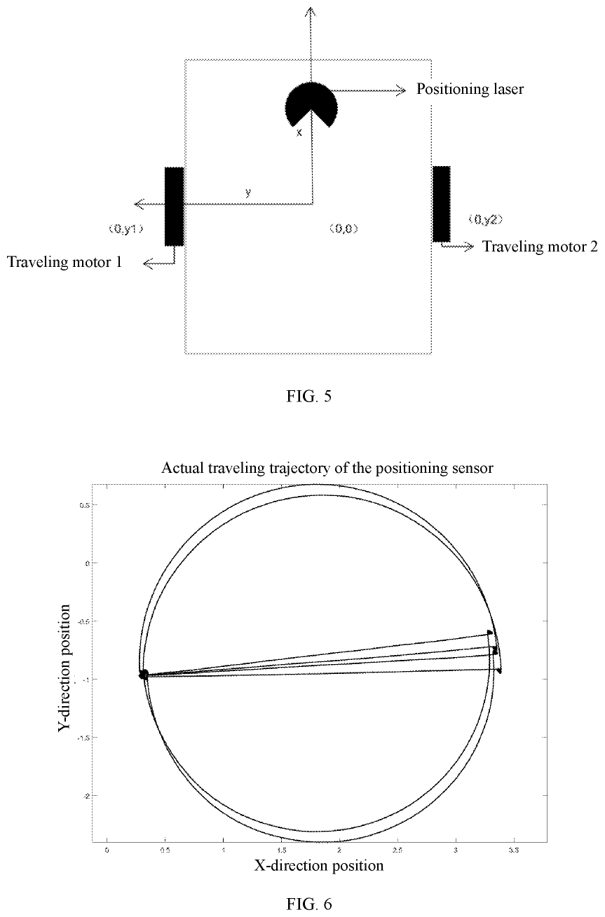

With respect to the two wheeled differential mobile robot shown in FIG. 5, k=2, I=0.

When the robot passes through a path, assuming that the positioning trajectory information and the information of the encoder data at N moments are recorded, total positioning information recorded when the robot passes through the path is Tₚ=[tₚ₁, tₚ₂, . . . , t_{pN}], the total data information of the encoder is U=[u₁, u₂, . . . , u_{N}], and N is the number of data points.

Step S200, ideal trajectory information of the mobile robot is deduced by the data of the motor encoder in combination with a kinematic model of the mobile robot.

Specifically, first, an offline odometer needs to be designed to deduce the ideal trajectory information \hat{T}_{c}=[\hat{t}_{c1}, \hat{t}_{c2}, . . . , t_{cN}] of the robot according to the data of the encoder and the kinematic model of the robot, where t_{ci},i=1, . . . N represents the ideal positioning position at the i^{th} moment. Different types of offline odometers are needed for different robot models.

With respect to the mobile robot model shown in FIGS. 3-5, the following needs to be designed: a dual steering wheel vehicle offline odometer, a single steering wheel vehicle offline odometer, and a two wheeled differential drive vehicle offline odometer.

Assuming that the data wₘᵢ of encoder recorded by the m^{th} traveling motor at the moment i is a cumulative distance traveled by the motor, and the data sₙᵢ of encoder recorded by the nth steering motor is an angle value of the steering motor at the current moment.

The distance Δwₘᵢ=_{wmi+i}−wₘᵢ traveled by the traveling motor between the moment i and the moment i+1 and a mean value ΔSₙᵢ=(Sₙᵢ₊₁+Sₙᵢ)/2 of the angle of the steering motor may be calculated.

According to this calculation method, the approximate distance traveled by each motor relative to the current position of the robot between the moment i and the moment i+1 may be calculated.

Among different types of robots, the number m of the traveling motors and the number n of the steering motors are not equal. In some robots, only traveling motors are provided without steering motors, while in others, traveling motors and steering motors are mounted as a pair of combined motors.

Therefore, in the derivation of the present patent, the calculation formulas for the traveling motors and the steering motors are unified into a single calculation form, and it is assumed that both the traveling motors and the steering motors are regarded as combined motors consisting of the traveling motors and the steering motors.

A calculation formula for the distance traveled by the kth motor (k=1,2, . . . , max(m,n)) relative to the current position of the robot between the moment i and the moment i+1 is as follows:

$$\{ \begin{matrix}Δ {x}_{k i} = Δ {w}_{k i} {R}_{k} cos ( Δ {S}_{k i} ) \\ Δ {y}_{k i} = Δ {w}_{k i} {R}_{k} sin ( Δ {S}_{k i} )\end{matrix} \qquad ( 1 )$$

It should be noted that after assuming that the motors are all combined motors, the number of k may be directly calculated as the number of positions where the motors are mounted.

In formula (1), for the traveling motors, assuming that a motor with the traveling motor and the steering motor are combined together, it may be considered that only the traveling motor acts, ΔSₖᵢ=0, such that a displacement in an x direction only exists.

For the steering motors, assuming that a motor with the traveling motor and the steering motor are combined together, it may be considered that only the steering motor acts, Δwₙᵢ=0, such that no displacement in the x direction and the y direction exists, only with a steering function.

For motors where the mounting positions of the traveling motor and the steering motor coincide (i.e., the motors with traveling and steering functions, such as steering wheel motors), displacements exist in both the x direction and y direction.

As shown in FIGS. 3-4, in the dual steering wheel and single steering wheel vehicle mobile robots, since the mounting positions of the steering motor and the traveling motor coincide, the distance traveled b the vehicle relative to the current position of the robot between the moment i and the moment i+1 in the x direction and y direction changes.

In the two wheel differential vehicle mobile robot shown in FIG. 5, since no steering motor exists, it may be considered that the steering angle of the steering motor is 0°, such that there is only position change in the x direction. Rₖ represents a radius of the traveling motor in the kth combined motor.

Δbᵢ=[Δx₁ᵢ, Δy₁ᵢ, . . . , Δxₖᵢ, Δyₖᵢ]^{T} is used to represent a distance traveled by each execution part of the robot between the moment i and the moment i+1. In Δbᵢ, the arrangement order of Δxₖᵢ, Δyₖᵢ and the number of k vary as the kinematic model of the robot varies.

According to the relationship between the traveling motor and the steering motor of the mobile robot and the movement of the robot, a calculation formula of a pose change Δt_{ci}=[Δx_{ci}Δy_{ci} Δα_{ci}]^{T} of the robot at each moment may be obtained (Δx_{ci} is the position change in the x direction, Δy_{ci} is the position change in the y direction, and Δα_{ci} is the change of the heading angle of the robot):

$$Δ {t}_{c i} = K Δ {b}_{i}$$

where the matrix K is a matrix that represents kinematic characteristics of the robot. Particularly, in calculation of the dual steering wheel vehicle offline odometer shown in FIG. 3, the steering wheel motor is defined a motor where the mounting positions of the steering motor and the traveling motor coincide. Calculation steps of the ideal trajectory information include:

$$Δ {b}_{i} = {[ Δ {x}_{1 i} , Δ {y}_{1 i} , Δ {x}_{2 i} , Δ {y}_{2 i} ]}^{T}$$

$$A = [ \begin{matrix}1 & 0 & - {y}_{1} \\ 0 & 1 & {x}_{1} \\ 1 & 0 & - {y}_{2} \\ 0 & 1 & {x}_{2}\end{matrix} ]$$

$$K = {( {A}^{T} A )}^{- 1} {A}^{T}$$

Δx₁ᵢ, Δy₁ᵢ, Δx₂ᵢ, Δy₂ᵢ are position changes of the first steering wheel motor and the second steering wheel motor at the moment i in the x-axis direction and the y-axis direction, respectively, x₁ and y₁, and x₂ and Y₂ are x-axis coordinates and y-axis coordinates of the first steering wheel motor and the second steering wheel motor under the coordinate system of the robot, T is transpose, and A is a kinematic characteristic matrix of the mobile robot in a non-overconstrained state(remark: in this model, the traveling motor and the steering motor are mounted at the same position, and in actual production, this mounting mode is also reasonable. Since the two wheel steering robot is in the overconstrained state at this time, the matrix K is the pseudo-inverse of kinematic matrix A.)

In calculation of the single steering wheel vehicle offline odometer shown in FIG. 4, the steering wheel motor is defined a motor where the mounting positions of the steering motor and the traveling motor coincide. Calculation steps of the ideal trajectory information include:

$$Δ {b}_{i} = {[ Δ {x}_{1 i} , Δ {y}_{1 i} ]}^{T}$$

$$K = [ \begin{matrix}1 & 0 \\ 0 & 1 \\ 0 & \frac{1}{{x}_{1}}\end{matrix} ]$$

where Δx₁ᵢ,Δy₁ᵢ is a position change of the first steering wheel motor in the x-axis direction and y-axis direction at the moment i, x₁ is an x-axis coordinate of the first steering wheel motor under the coordinate system of the robot, and T is a transpose.

In calculation of the two wheel differential vehicle offline odometer shown in FIG. 5, the differential wheel motor is defined as the traveling motor, where Δyₖᵢ is 0, which is neglected in the following formula. Calculation steps of the ideal trajectory information include:

$$Δ {b}_{i} = {[ Δ {x}_{1 i} , Δ {y}_{1 i} ]}^{T}$$

$$K = [ \begin{matrix}\frac{1}{2} cos ( {α}_{ci} ) & \frac{1}{2} cos ( {α}_{ci} ) \\ \frac{1}{2} sin ( {α}_{ci} ) & \frac{1}{2} sin ( {α}_{ci} ) \\ - \frac{1}{( {y}_{1} - {y}_{2} )} & \frac{1}{( {y}_{1} - {y}_{2} )}\end{matrix} ]$$

where Δx₁ᵢ,Δx₂ᵢ are position changes of the first traveling motor and the second traveling motor in the x-axis direction at the moment i, y₁ and y₂ are respectively y-axis coordinates of the first traveling motor and the second traveling motor under the coordinate system of the robot, α_{ci} is a heading angle of the mobile robot at the moment i, α_{ci+1}=α_{ci}+Δα_{ci},1≤i≤n, α_{ci} is a heading angle of the robot at an initial moment, and T is a transpose.

Further, the pose of the offline odometer at the initial moment may directly be a pose t_{c1}=[x_{c1} y_{c1} α_{c1}]^{T} of the robot in this positioning environment. The method for converting the pose data obtained by the positioning sensor at the initial moment into the pose data of the robot at the initial moment may be similarly obtained with reference to calculation formula 2 in the following Step S300.

With respect to the robot based on the initial pose data and the data calculated from the motor encoder data, by accumulating motion data Δt_{ci}=[Δx_{ci} Δy_{ci} Δα_{ci}]^{T} at each moment, an ideal offline trajectory \hat{T}_{c}=[\hat{t}_{c1}=\hat{t}_{c1} \hat{t}_{c2}=\hat{t}_{c1}+Δt_{c1}, . . . , \hat{t}_{cN}\hat{t}_{c(N-1)}+Δt_{c(N-1)}] of the robot driven by motor encoder data may be calculated.

The above is a calculation example in which the ideal trajectory of the mobile robot driven by the data of the encoder is estimated by the offline odometer based on data information from motor encoders and in combination with the kinematic model of the robot.

From the above derivation of the offline odometer, it may be seen that the ideal trajectory information \hat{T}_{c}=[\hat{t}_{c1}, \hat{t}_{c2}, . . . , \hat{t}_{cN}] of the robot under the recorded encoder data can be calculated according to the data information U=[u₁, u₂, . . . , u_{N}] of the encoder.

Step S300, the positioning trajectory data is converted into trajectory information of the mobile robot according to a mounting position of the positioning sensor, and then least squares problem solving is performed after differential alignment with the ideal trajectory information is performed to acquire calibrated kinematic parameters of the mobile robot and mounting parameters of the positioning sensor.

Specifically, the step of converting the positioning trajectory information into the trajectory information of the mobile robot according to the mounting position of the positioning sensor includes:

Step S301: with respect to a position vector [x, y, ∝]^{T} including a position x, y and an angle α, a homogeneous transformation matrix corresponding thereto exists:

$$[ \begin{matrix}cos ( α 1 ) & - sin ( α 1 ) & x 1 \\ sin ( α 1 ) & cos ( α 1 ) & y 1 \\ 0 & 0 & 1\end{matrix} ] ,$$

where this transformation is denoted as Pose2Trans( ).

Assuming the trajectory information of the positioning sensor of the robot as T_{P}=[tₚ₁, tₚ₂, . . . , t_{pN}], the mounting position of the positioning sensor relative to the center of the coordinates of the robot as [xₚ, yₚ, αₚ], and the trajectory information of the robot as T_{c}=[t_{c1}, t_{c2}, . . . , t_{cN}], a calculation relationship among the three is as follows:

$$P o s e 2 T r a n s ( {t}_{p i} ) = P o s e 2 T r a n s ( {t}_{c i} ) [ \begin{matrix}cos ( {α}_{p} ) & - sin ( {α}_{p} ) & {x}_{p} \\ sin ( {α}_{p} ) & cos ( {α}_{p} ) & {y}_{p} \\ 0 & 0 & 1\end{matrix} ] \qquad ( 2 )$$

Further, the step of performing differential alignment on the trajectory information of the mobile robot with the ideal trajectory information includes:

Step S302: the purpose of the differential alignment operation is to separate the motion characteristics of the robot in each time period in the operating process from the overall operating trajectory, and a calculation process is as follows.

The trajectory information of the robot is known as T_{c}=[t_{c1}, t_{c2}, . . . , t_{cN}], t_{ci}=[x_{ci}, y_{ci}, α_{ci}]^{T}, the differential spacing ndiff, and a homogeneous transformation relationship between the vector t_{ci} and the vector t_{c(i+ndiff)} may be calculated as follows:

$$P o s e 2 T r a n s ( {t}_{c ( i + ndiff )} ) = Pose 2 Trans ( {t}_{c i} ) [ \begin{matrix}cos ( d {α}_{i} ) & - sin ( d {α}_{i} ) & {dx}_{i} \\ sin ( d {α}_{i} ) & cos ( d {α}_{i} ) & {dy}_{i} \\ 0 & 0 & 1\end{matrix} ] \qquad ( 3 )$$

A differential alignment trajectory DT_{c}=[dt_{c1},dt_{c2}, . . . ,dt_{c(N-ndiff)}] may be solved, where dt_{ci}=[dxᵢ, dyᵢ, daᵢ]^{T}.

Formula (3) is obtained from differential data t_{ci} and t_{c(i+ndiff)} of the trajectory via homogeneous transformation. Therefore, formula (3) is also known as a differential alignment formula.

Similarly, according to formula (3), it may be obtained that for the ideal robot trajectory \hat{T}_{c}=[\hat{t}_{c1}, \hat{t}_{c2}, . . . , t_{cN}], there is a differential alignment formula

$$Pose 2 T r a ns ( {\hat{t}}_{c ( i + ndiff )} ) = Pose 2 Trans ( {\hat{t}}_{c i} ) [ \begin{matrix}cos ( d {\hat{α}}_{i} ) & - sin ( d {\hat{α}}_{i} ) & d {\hat{x}}_{i} \\ sin ( d {\hat{α}}_{i} ) & cos ( d {\hat{α}}_{i} ) & d {\hat{y}}_{i} \\ 0 & 0 & 1\end{matrix} ] \qquad ( 4 )$$

Therefore, a differential trajectory D\hat{T}_{c}=[d\hat{t}_{c1},d\hat{t}_{c2}, . . . , d\hat{t}_{c(N-ndiff)}] of the ideal robot trajectory may be calculated, where d\hat{t}_{ci}=[d\hat{x}ᵢ, dŷᵢ, dαᵢ]^{T}.

Finally, the step of least squares problem solving includes:

step S300: in order to obtain a set of kinematic parameters and sensor parameters that enable the motion characteristics of the robot in each time period to be as close as possible to the actual motion characteristics, it is desirable that the differential alignment data dt_{ci} of the positioning trajectory at each moment be as equal as possible to the differential alignment data d\hat{t}_{ci} of the ideal trajectory at that moment.

Therefore, the cost function is designed in the following least squares form.

$$f = {\sum }_{i = 1}^{N - ndiff} {( \hat{d} {t}_{c i} - d {t}_{c i} )}^{T} ( \hat{d} {t}_{c i} - d {t}_{c i} ) \qquad ( 5 )$$

where N-ndiff represents the number of data points after differential alignment, a value thereof is a difference between the number N of trajectory points and a differential interval ndiff, \hat{d}t_{ci} is an ideal trajectory positioning position at the moment i after differential alignment, dt_{ci} is a trajectory positioning position of the mobile robot after differential alignment, and T is a transpose.

Further, there are many methods for least squares problem solving, such as a gradient descent method, a Newton's method, a Gauss-Newton method, and a Levenberg-Marquarelt (LM) algorithm. The LM algorithm is preferred in this example (the LM algorithm is an algorithm for iteratively solving the extremum of a function). Since it approximates the gradient descent method when far from the optimal solution and approximates the Gauss-Newton method when close to the optimal solution, it has high convergence efficiency. Furthermore, as a common algorithm for solving nonlinear least squares problems, its calculation process belongs to the prior art and thus will not be described in detail herein.

In addition, it is worth noting that the LM algorithm is used in this patent for least squares problem solving. In constructing the least squares problem of this patent, if the LM algorithm for solving this least squares problem is regarded as a controller, the tracking output signal of the controller is the differential alignment data of the robot positioning trajectory, and the input signals are the kinematic model parameters and sensor mounting parameters of the robot.

For example:
with respect to the dual wheeled steering vehicle shown in FIG. 3, the kinematic model parameters are as follows: the wheel radius r of the vehicle, the positions x, y where the wheels are mounted, and an angle difference Δδ between two steering angle offsets.

With respect to the single wheeled steering vehicle shown in FIG. 4, the kinematic model parameters are as follows: the wheel radius r of the vehicle, and the position x where the wheels are mounted.

With respect to the dual differential drive vehicle shown in FIG. 5, the kinematic model parameters are as follows: the wheel radius r of the vehicle, and the position x where the wheels are mounted.

The mounting parameters of the sensor are as follows: the mounting position of the sensor in the x direction, the mounting position of the sensor in the y direction, and the mounting angle of the sensor relative to the positive direction of the x-axis of the vehicle body.

In step S301, the positioning trajectory information of the robot may be calculated according to the information of the positioning sensor of the robot and the mounting position of the positioning sensor.

In step S200, the ideal trajectory information of the robot may be calculated according to the data of the encoder and the kinematic model parameters of the robot recorded.

In step S302, the robot positioning trajectory and the ideal trajectory of the robot may be converted into variables in formula 5 in step S303 via formulae 3-4.

Therefore, the relationship between the kinematic parameters of the robot, the mounting position parameters of the positioning sensor, and the least squares cost function (formula 5) may thus be established. During LM solving, by continuously iterating values of kinematic parameters and mounting position parameters of the positioning sensor, a set of parameters that minimize the cost function in formula 5 are obtained as the final solution.

Thus, the goal of this example is to determine a set of kinematic parameters of the robot and mounting parameters of the positioning sensor such that the motion characteristics in each time interval are as close as possible to the actual motion characteristics.

### Experimental Example I

The dual steering wheel vehicle shown in FIG. 3 is taken as an example.

During calculation of the first steering wheel motor and the second steering wheel motor, the steering motor and the traveling motor are mounted at the same position. It is known that the mounting position of the first traveling motor is (0.65 m, 0.45 m), the wheel radius thereof is 0.08 m, the mounting position of the second traveling motor is (−0.65 m, −0.45 m), and the wheel radius thereof is 0.08 m.

The mounting position of laser relative to the vehicle body coordinate system is defined as (0.7 m, 0.5 m, −40°), and before calibration, an assumption is made below: the wheel radii of the two traveling motors are the same, i.e., r1=r2=r.

The mounting positions of the two wheels are symmetrical about the origin of coordinates of the robot, i.e., x1=−x2=x, y1=−y2=y. The steering angle offsets of the two steering motors have been compensated. The kinematic parameters of the robot needed to be finally calibrated are as follows: the wheel radius r of the vehicle, the mounting positions x, y of the wheels, an angle difference Δδ between two steering angle offsets, and the mounting position xₚ, yₚ, αₚ of the positioning sensor relative to the coordinate system of the robot.

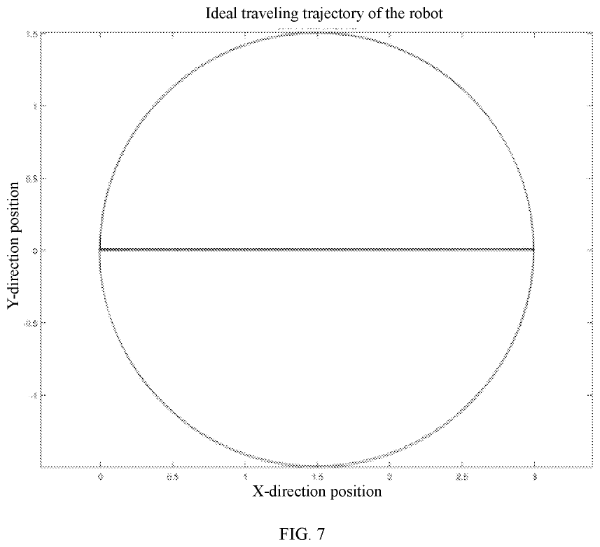

The process is as follows:
1. With respect to the dual steering wheel vehicle, to cause the robot to travel along a path including various different motion models in one run, the traveling path of the robot is designed as a Θ-shaped path (the shape of the path is shown in FIG. 7). The diameter of the θ-shaped path in this example is 3 m, and the robot is driven to travel along the trajectory twice. The actual positioning trajectory of the robot under this behavior is shown in FIG. 6.
2. According to data information stored by the encoder, in combination with the kinematic parameters of the robot, the ideal traveling trajectory of the robot is calculated. With respect to the kinematic matrices,

$$A = [ \begin{matrix}1 & 0 & - 0.45 \\ 0 & 1 & 0.65 \\ 1 & 0 & 0.45 \\ 0 & 1 & - 0.65\end{matrix} ] K = [ \begin{matrix}0.5 & 0 & 0.5 & 0 \\ 0 & 0.5 & 0 & 0.5 \\ - 0.36 & 0.52 & 0.36 & - 0.52\end{matrix} ]$$

data of the motor encoder in a forward-right turning mode at a moment is analyzed, and in this case, Δw₁ᵢ=0.02654 m, Δs₁ᵢ=72.356°, Δw₂ᵢ=0.02582 m, Δs₁ᵢ=70.523°, and Δbᵢ=[0.00064362 m 0.002 m 0.0006888 m 0.0019 m]^{T} at this moment is obtained according to current r=0.08. It is introduced into the kinematic matrix K to obtain the pose change Δt_{ci}=[0.0007 m 0.0019 m 0.0001rad]^{T} at this moment. Accordingly, the ideal trajectory of the robot, which may be calculated by continuously accumulating the pose changes at each moment based on the initial pose, is shown in FIG. 7.
3. Since the mounting position of the positioning sensor is (0.7 m, 0.5 m, −40°), the trajectory information of the sensor may be converted into Tₚ, which is converted into the actual trajectory information T_{c} via matrix transformation.

$$P o s e 2 T r a n s ( {t}_{c i} ) = P o s e 2 T r a n {s ( {t}_{p i} ) [ \begin{matrix}0.7661 & - 06428 & 0.7 \\ 0.6428 & 0.7661 & 0.5 \\ 0 & 0 & 1\end{matrix} ]}^{- 1}$$

4. The parameter calibration result is obtained by constructing a nonlinear least squares problem based on the actual traveling trajectory and ideal trajectory of the robot and solving it using the LM algorithm: r=0.08105 m, x=0.65112 m, y=0.44998 m, Δδ=0.12541°, xₚ=0.69682 m, yₚ=0.51088 m, αₚ=−41.00248°.

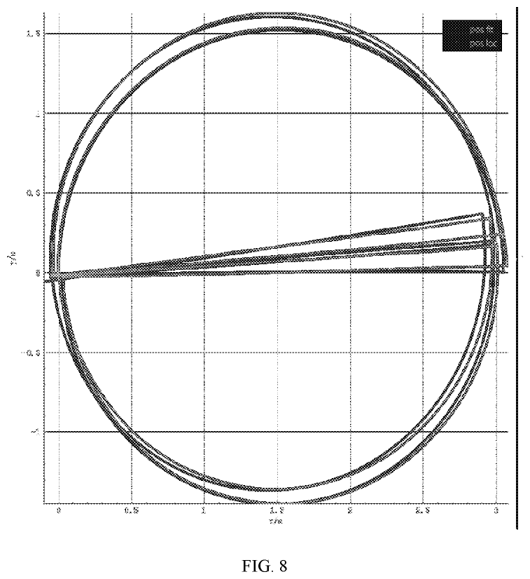

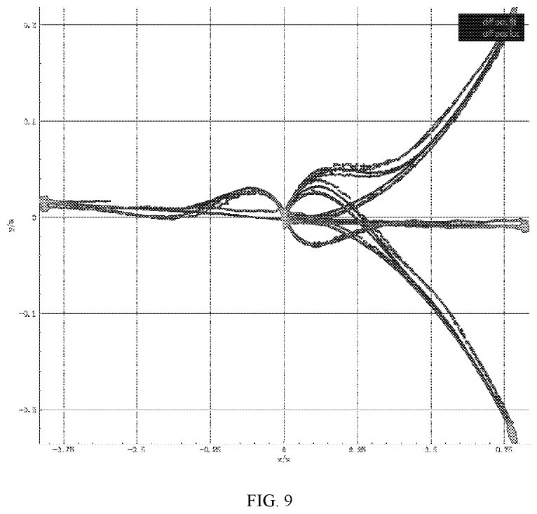

The above calibration parameters are substituted into the offline odometers and compared with the true trajectory. FIG. 8 shows the trajectory diagram, and FIG. 9 shows a differential alignment diagram. Its fitting error converges from an initial 0.213 m to 0.01403 m. Since positioning errors are inevitably introduced during the measurement of positioning information, the final fitting error is within an acceptable range.

### Experiment Example II

The single steering wheel shown in FIG. 4 is taken as an example.

During calculation of the first steering wheel motor, the steering motor and the traveling motor may be mounted at the same position. It is known that the mounting position of the first traveling motor is (0.877 m, 0 m), the wheel radius thereof is 0.115 m.

The mounting position of laser relative to the vehicle body coordinate system is defined as (0.902 m, 0 m, 0°). Before calibration, an assumption is made below: the steering angle offset of the steering motor has been compensated, and the axes of the two driven wheels of the rear wheels coincide with and are parallel to the y axis of the coordinate system of the robot. The kinematic parameters of the robot needed to be finally calibrated are as follows: the wheel radius r of the vehicle, the mounting positions x1 of the wheels, and the mounting position xₚ,yₚ,αₚ of the positioning sensor relative to the coordinate system of the robot.

The process is as follows:
1. With respect to the single steering wheel vehicle, to cause the robot to travel along a path including various different motion models in one run, the traveling path of the robot is a three-parallel-line path. As shown in FIG. 10, the length of the path is 3 m, and the robot is driven to travel back and forth along the trajectory twice.
2. According to data information stored by the encoder, in combination with the kinematic parameters of the robot, the ideal traveling trajectory of the robot is calculated. With respect to the kinematic matrices,

$$K = [ \begin{matrix}1 & 0 \\ 0 & 1 \\ 0 & 1.1403\end{matrix} ]$$

Data of the motor encoder in a forward-left turning mode at a moment is analyzed, and in this case, Δw₁ᵢ=0.0352 m, Δs₁ᵢ=36.28°.

Δbᵢ=[0.0033 m 0.0024 m]^{T} at this moment is obtained according to current r=0.115 m. It is introduced into the kinematic matrix K to obtain the pose change Δt_{ci}=[0.0033 m 0.0024 m 0.0027rad]^{T} at this moment. Accordingly, the ideal trajectory of the robot, which may be calculated by continuously accumulating the pose changes at each moment based on the initial pose, is shown in FIG. 7.
3. Since the mounting position of the positioning sensor is (0.902 m, 0 m, 0°), the trajectory information of the sensor may be converted into Tₚ, which is converted into the actual trajectory information T_{c} via matrix transformation.

$$P o s e 2 T r a n s ( {t}_{c i} ) = P o s e 2 T r a n {s ( {t}_{p i} ) [ \begin{matrix}1 & 0 & 0.902 \\ 0 & 1 & 0 \\ 0 & 0 & 1\end{matrix} ]}^{- 1}$$

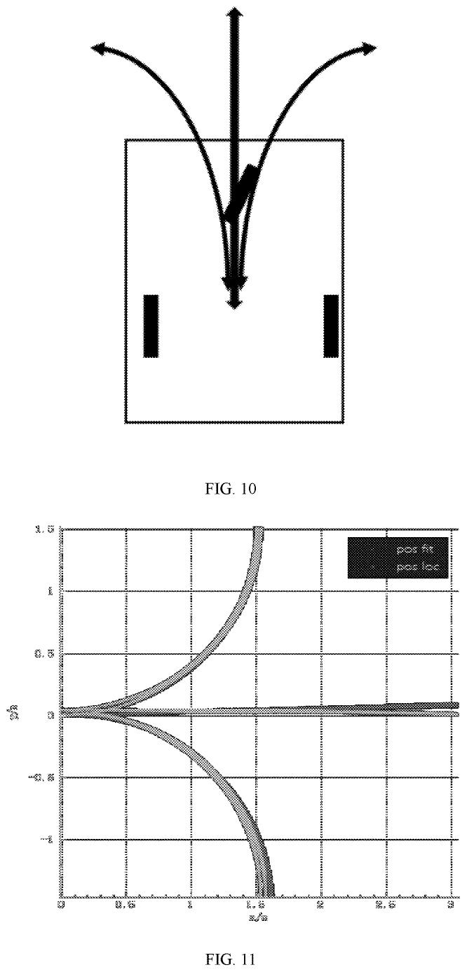

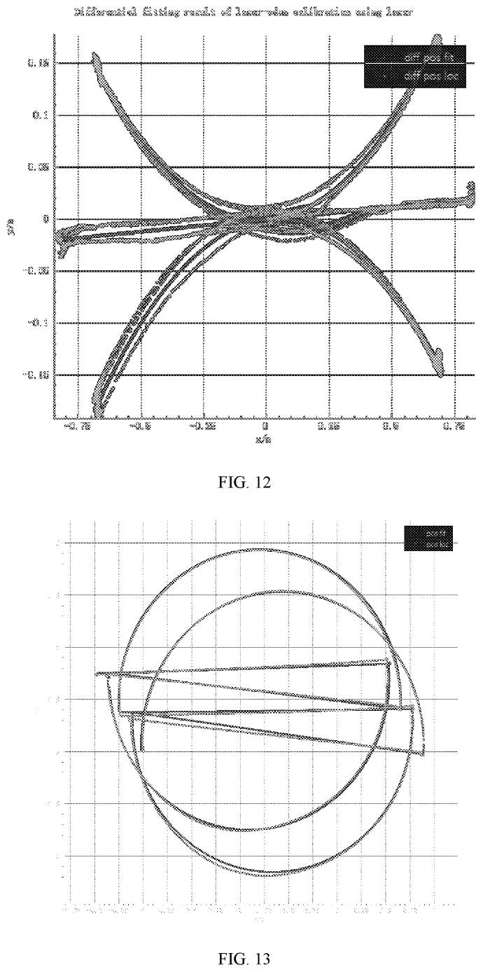

4. The parameter calibration result is obtained by constructing a nonlinear least squares problem based on the actual traveling trajectory and ideal trajectory of the robot and solving it using the LM algorithm: r=0.11612 m, x1=0.877 m, xₚ=0.9035 m, yₚ=0 m, αₚ=−0.32°. The above calibration parameters are substituted into the offline odometers and compared with the true trajectory. FIG. 11 shows the trajectory diagram, and FIG. 12 shows a differential alignment diagram.

### Experimental Example III

The two wheeled differential vehicle shown in FIG. 5 is taken as an example.

It is known that the mounting position of the first traveling motor is (0 m, 0.315 m), the wheel radius thereof is 0.08 m. The mounting position of the second traveling motor is (0 m, −0.315 m), the wheel radius thereof is 0.08 m. The mounting position of laser relative to the vehicle body coordinate system is defined as (0.39 m, 0 m, 0°). Before calibration, an assumption is made below: the wheel radii of the two traveling motors are the same, i.e., r1=r2=r, and the positions of the two wheels are symmetrical about the odometry center of the robot. The kinematic parameters of the robot needed to be finally calibrated are as follows: the wheel radius r of the vehicle, and the distance y1-y2 between the two traveling motors. The mounting position xₚ, yₚ, αₚ of the positioning sensor relative to the coordinate system of the robot.

The process is as follows:
1. With respect to the two wheeled differential vehicle, to cause the robot to travel along a path including various different motion models in one run, the traveling path of the robot is also designed as a Θ-shaped path (the shape of the path is shown in FIG. 7). The length of the Θ-shaped path is 3 m, and the robot is driven to travel back and forth along the trajectory twice.
2. According to data information stored by the encoder, in combination with the kinematic parameters of the robot, the ideal traveling trajectory of the robot is calculated.

Data of the motor encoder in a forward-right turning mode at a moment is analyzed, in this case, the heading angle is α_{ci}=35.65°.

$$K = [ \begin{matrix}0.4063 & 0.4063 \\ 0.2914 & 0.2914 \\ - 1.5873 & 1.5873\end{matrix} ]$$

In this case, Δw₁ᵢ=0.03562 m, Δw₂ᵢ=0.03157 m. Δbᵢ=[0.0028 m 0.0025 m]^{T} at this moment is obtained according to current r=0.08 m. It is introduced into the kinematic matrix K to obtain the pose change Δt_{ci}=[0.0022 m 0.0015 m−0.000476rad]^{T} at this moment. Accordingly, the ideal trajectory of the robot, which may be calculated by continuously accumulating the pose changes at each moment based on the initial pose, is shown in FIG. 7.
3. Since the mounting position of the positioning sensor is (0.39 m, 0 m, 0°), the trajectory information of the sensor may be converted into Tₚ, which is converted into the actual trajectory information T_{c} via matrix transformation, i.e.,

$$P o s e 2 T r a n s ( {t}_{c i} ) = P o s e 2 T r a n {s ( {t}_{p i} ) [ \begin{matrix}1 & 0 & 0.39 \\ 0 & 1 & 0 \\ 0 & 0 & 1\end{matrix} ]}^{- 1}$$

4. The parameter calibration result is obtained by constructing a nonlinear least squares problem based on the actual traveling trajectory and ideal trajectory of the robot and solving it using the LM algorithm: r=0.082 m, y1=−y2=0.3172 m, xₚ=0.3927 m, yₚ=0 m, αₚ=1.57°.

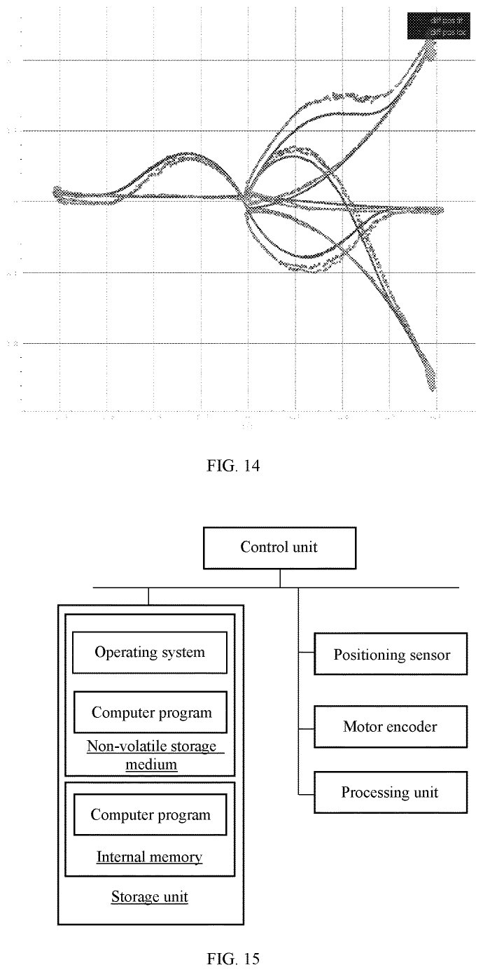

The above calibration parameters are substituted into the offline odometers and compared with the true trajectory. FIG. 13 shows the trajectory diagram, and FIG. 14 shows a differential alignment diagram.

Corresponding to the above method, referring to FIG. 15, a second aspect of the present disclosure further provides a joint parameter calibration system for a mobile robot, including:
a storage unit, configured to store a program comprising steps of the joint parameter calibration method for a mobile robot according to any one of the above for a control unit and a processing unit to timely retrieve and execute;
the control unit, configured to control the mobile robot to travel along a path passing through all modes, correspondingly record positioning trajectory data of a positioning sensor and data of a motor encoder, and send the same to the processing unit; and
the processing unit, configured to deduce ideal trajectory information of the mobile robot by the data of the motor encoder in combination with a kinematic model of the mobile robot; and convert the positioning trajectory data into trajectory information of the mobile robot according to a mounting position of the positioning sensor, and then perform least squares problem solving after performing differential alignment with the ideal trajectory information to acquire calibrated kinematic parameters of the mobile robot and mounting parameters of the positioning sensor, thereby acquiring the calibrated kinematic parameters of the mobile robot and the mounting parameters of the positioning sensor.

Corresponding to the above method, a third aspect of the present disclosure further provides a computer device, including a memory and a processor, the memory storing a computer program, where the processor, when executing the computer program, implements the steps of the method of any one of the above.

Corresponding to the above method, a fourth aspect of the present disclosure further provides a computer-readable storage medium, storing a computer program, where the computer program, when executed by a processor, implements the steps of the method of any one of the above.

To sum up, through the joint parameter calibration method and system for a mobile robot, the device, and the storage medium provided by the present disclosure, aiming at the errors in the manufacturing and mounting processes of kinematic components of the mobile robot, the kinematic and sensor parameters are calibrated at the same time based on the least squares method, thereby improving the operating precision of the robot.

In addition, by causing the mobile robot to automatically travel along a predesigned path that includes all motion modes of the robot in one run and recording the positioning information of the positioning sensor and the information of the motor encoder, the required parameter calibration may be completed in a single operation. In addition, the differential alignment operation on the actual positioning information and the ideal positioning information may effectively utilize information of kinematic characteristics in the operating process of the robot, thereby improving the convergence efficiency during parameter calculation.

The preferred embodiments of the present invention disclosed above are merely used for expounding the present invention. The preferred embodiments do not narrate all details and should not be construed as limitations of the specific implementations of the present invention. Obviously, various modifications and transformations may be made according to the contents in the specification. The embodiments selected and specifically described here are merely used for better explaining the principle and actual application of the present invention to allow those skilled in the art to well understand and use the present invention. The present invention is limited only by the claims and the scope and equivalents thereof, and any modifications, equivalent substitutions and improvements made on the basis of the spirit and principle of the present invention should fall within the protection scope of the present invention.

Those skilled in the art may understand that in addition to implementing the system, device and modules provided by the present invention by means of pure computer-readable program codes, the steps of the method may be logically programmed to allow the system, device and modules provided by the present invention to implement the same program in the form of a logic gate, a switch, an application-specific integrated circuit, a programmable logic controller and an embedded microcontroller. Therefore, the system, device and modules provided by the present invention may be regarded as a hardware component, and modules for implementing various programs inside may be regarded as structures in the hardware component; or, the modules for achieving various functions may be regarded as a software program for implementing the method or structures in the hardware component.

All or part of the steps of the method in the above embodiments may be completed by related hardware instructed by a program, and the program is stored in a storage medium and includes a plurality of instructions for causing a single-chip microcomputer, a chip or a processor to implement all or part of the steps of the method in the embodiments of the application. The storage medium include various media for storing program codes such as a USB flash disk, a mobile hard disk drive, a read-only memory (ROM), a random access memory (RAM), a diskette and a CD.

In addition, different implementations of the embodiments of the present invention may be combined freely without violating the concept of the embodiments of the present invention, and all these combinations should also be construed as contents disclosed by the embodiments of the present invention.

1. A joint parameter calibration method and system for a mobile robot, comprising:
step S100, causing the mobile robot to travel along a path passing through all modes, and correspondingly recording positioning trajectory data of a positioning sensor and data of a motor encoder;
step S200, deducing ideal trajectory information of the mobile robot by the data of the motor encoder in combination with a kinematic model of the mobile robot; and
step S300, converting the positioning trajectory data into trajectory information of the mobile robot according to a mounting position of the positioning sensor, and then performing least squares problem solving after performing differential alignment with the ideal trajectory information to acquire calibrated kinematic parameters of the mobile robot and mounting parameters of the positioning sensor, thereby realizing automatic calibration in one step, where the kinematic parameters of the robot and the mounting parameters of the positioning sensor are calibrated simultaneously.

2. The method according to claim 1, wherein in step S200,
calculation steps of the ideal trajectory information comprise: calculating
$$Δ {t}_{c i} = K Δ {b}_{i} ,$$
wherein Δt_{ci} is a pose change of the mobile robot at each moment; K is a kinematic model of the mobile robot; Δbᵢ is a distance traveled by each execution component of the mobile robot at a moment i; and
then, calculating the ideal trajectory information by accumulating initial pose data and Δt_{ci}.

3. The method according to claim 2, wherein when the mobile robot is of a dual steering wheel structure, a steering wheel motor is defined such that the steering motor and the traveling motor are coaxially mounted, and the calculation steps of the ideal trajectory information comprise:
$$letting Δ {b}_{i} = {[ Δ {x}_{1 i} , Δ {y}_{1 i} , Δ {x}_{2 i} , Δ {y}_{2 i} ]}^{T} ,$$
$$A = [ \begin{matrix}1 & 0 & - {y}_{1} \\ 0 & 1 & {x}_{1} \\ 1 & 0 & - {y}_{2} \\ 0 & 1 & {x}_{2}\end{matrix} ]$$
$$K = {( {A}^{T} A )}^{- 1} {A}^{T}$$
wherein Δx₁ᵢ, Δy₁ᵢ, Δx₂ᵢ, Δy₂ᵢ are position changes of the first steering wheel motor and the second steering wheel motor in an x-axis direction and a y-axis direction at the moment i, x₁ and y₁, and x₂ and Y₂ are x-axis coordinates and y-axis coordinates of the first steering wheel motor and the second steering wheel motor under the coordinate system of the robot, T is transpose, and A is a kinematic characteristic matrix of the mobile robot in a non-overconstrained state.

4. The method according to claim 2, wherein when the mobile robot is of a single steering wheel structure, a steering wheel motor is defined such that the steering motor and the traveling motor are coaxially mounted, and the calculation steps of the ideal trajectory information comprise:
$$letting Δ {b}_{i} = {[ Δ {x}_{1 i} , Δ {y}_{1 i} ]}^{T} ,$$
$$K = [ \begin{matrix}1 & 0 \\ 0 & 1 \\ 0 & \frac{1}{{x}_{1}}\end{matrix} ]$$
wherein Δx₁ᵢ, Δy₁ᵢ is a position change of the first steering wheel motor in x and y-axis directions at the moment i, x₁ is an x-axis coordinate of the first steering wheel motor under the coordinate system of the robot, and T is a transpose.

5. The method according to claim 2, wherein when the mobile robot is of a dual differential drive wheel structure, a differential wheel motor is defined as a traveling motor, and the calculation steps of the ideal trajectory information comprise:
$$letting Δ {b}_{i} = {[ Δ {x}_{1 i} , Δ {x}_{2 i} ]}^{T} ,$$
$$K = [ \begin{matrix}\frac{1}{2} cos ( {α}_{ci} ) & \frac{1}{2} cos ( {α}_{ci} ) \\ \frac{1}{2} sin ( {α}_{ci} ) & \frac{1}{2} sin ( {α}_{ci} ) \\ - \frac{1}{{y}_{1} - {y}_{2}} & \frac{1}{{y}_{1} - {y}_{2}}\end{matrix} ]$$
wherein Δx₁ᵢ, Δx₂ᵢ are position changes of the first traveling motor and the second traveling motor in the x-axis direction at the moment i, y₁ and y₂ are respectively y-axis coordinates of the first traveling motor and the second traveling motor under the coordinate system of the robot, α_{ci} is a heading angle of the mobile robot at the moment i, α_{ci+1}=a_{ci}+Δα_{ci}, 1≤i≤n, α_{c1} is a heading angle of the robot at an initial moment, and T is a transpose.

6. The method according to claim 1, wherein in step S300, the least-squares problem is as follows:
$$f = {\sum }_{i = 1}^{N - ndiff} {( \hat{d} {t}_{c i} - d {t}_{c i} )}^{T} ( \hat{d} {t}_{c i} - d {t}_{c i} )$$
wherein N-ndiff represents the number of data points after differential alignment, a value thereof is a difference between the number N of trajectory points and a differential interval ndiff, \hat{d}t_{ci} is an ideal trajectory positioning position at the moment i after differential alignment, “d” “t”_“ci” is a trajectory positioning position of the mobile robot after differential alignment, and T is a transpose; and through an iterative calculation, a parameter with a minimum cost function value is taken as the calibrated kinematic parameter of the mobile robot and the mounting parameter of the positioning sensor.

7. A joint parameter calibration system for a mobile robot, comprising:
a storage unit, configured to store a program comprising steps of the joint parameter calibration method for a mobile robot according to claim 1 for a control unit and a processing unit to timely retrieve and execute;
the control unit, configured to control the mobile robot to travel along a path passing through all modes, correspondingly record positioning trajectory data of a positioning sensor and data of a motor encoder, and send the same to the processing unit; and
the processing unit, configured to deduce ideal trajectory information of the mobile robot by the data of the motor encoder in combination with a kinematic model of the mobile robot; and convert the positioning trajectory data into trajectory information of the mobile robot according to a mounting position of the positioning sensor, and then perform least squares problem solving after performing differential alignment with the ideal trajectory information to acquire calibrated kinematic parameters of the mobile robot and mounting parameters of the positioning sensor, thereby acquiring the calibrated kinematic parameters of the mobile robot and the mounting parameters of the positioning sensor.

8. A computer device, comprising a memory and a processor, the memory storing a computer program, wherein when executing the computer program, the processor implements the steps of the method according to claim 1.

9. A computer-readable storage medium, storing a computer program, wherein when executed by a processor, the computer program implements the steps of the method according to claim 1.

10. A joint parameter calibration system for a mobile robot, comprising:
a storage unit, configured to store a program comprising steps of the joint parameter calibration method for a mobile robot according to claim 2 for a control unit and a processing unit to timely retrieve and execute;
the control unit, configured to control the mobile robot to travel along a path passing through all modes, correspondingly record positioning trajectory data of a positioning sensor and data of a motor encoder, and send the same to the processing unit; and
the processing unit, configured to deduce ideal trajectory information of the mobile robot by the data of the motor encoder in combination with a kinematic model of the mobile robot; and convert the positioning trajectory data into trajectory information of the mobile robot according to a mounting position of the positioning sensor, and then perform least squares problem solving after performing differential alignment with the ideal trajectory information to acquire calibrated kinematic parameters of the mobile robot and mounting parameters of the positioning sensor, thereby acquiring the calibrated kinematic parameters of the mobile robot and the mounting parameters of the positioning sensor.

11. A joint parameter calibration system for a mobile robot, comprising:
a storage unit, configured to store a program comprising steps of the joint parameter calibration method for a mobile robot according to claim 3 for a control unit and a processing unit to timely retrieve and execute;
the control unit, configured to control the mobile robot to travel along a path passing through all modes, correspondingly record positioning trajectory data of a positioning sensor and data of a motor encoder, and send the same to the processing unit; and
the processing unit, configured to deduce ideal trajectory information of the mobile robot by the data of the motor encoder in combination with a kinematic model of the mobile robot; and convert the positioning trajectory data into trajectory information of the mobile robot according to a mounting position of the positioning sensor, and then perform least squares problem solving after performing differential alignment with the ideal trajectory information to acquire calibrated kinematic parameters of the mobile robot and mounting parameters of the positioning sensor, thereby acquiring the calibrated kinematic parameters of the mobile robot and the mounting parameters of the positioning sensor.

12. A joint parameter calibration system for a mobile robot, comprising:
a storage unit, configured to store a program comprising steps of the joint parameter calibration method for a mobile robot according to claim 4 for a control unit and a processing unit to timely retrieve and execute;
the control unit, configured to control the mobile robot to travel along a path passing through all modes, correspondingly record positioning trajectory data of a positioning sensor and data of a motor encoder, and send the same to the processing unit; and
the processing unit, configured to deduce ideal trajectory information of the mobile robot by the data of the motor encoder in combination with a kinematic model of the mobile robot; and convert the positioning trajectory data into trajectory information of the mobile robot according to a mounting position of the positioning sensor, and then perform least squares problem solving after performing differential alignment with the ideal trajectory information to acquire calibrated kinematic parameters of the mobile robot and mounting parameters of the positioning sensor, thereby acquiring the calibrated kinematic parameters of the mobile robot and the mounting parameters of the positioning sensor.

13. A joint parameter calibration system for a mobile robot, comprising:
a storage unit, configured to store a program comprising steps of the joint parameter calibration method for a mobile robot according to claim 5 for a control unit and a processing unit to timely retrieve and execute;
the control unit, configured to control the mobile robot to travel along a path passing through all modes, correspondingly record positioning trajectory data of a positioning sensor and data of a motor encoder, and send the same to the processing unit; and
the processing unit, configured to deduce ideal trajectory information of the mobile robot by the data of the motor encoder in combination with a kinematic model of the mobile robot; and convert the positioning trajectory data into trajectory information of the mobile robot according to a mounting position of the positioning sensor, and then perform least squares problem solving after performing differential alignment with the ideal trajectory information to acquire calibrated kinematic parameters of the mobile robot and mounting parameters of the positioning sensor, thereby acquiring the calibrated kinematic parameters of the mobile robot and the mounting parameters of the positioning sensor.

14. A joint parameter calibration system for a mobile robot, comprising:
a storage unit, configured to store a program comprising steps of the joint parameter calibration method for a mobile robot according to claim 6 for a control unit and a processing unit to timely retrieve and execute;
the control unit, configured to control the mobile robot to travel along a path passing through all modes, correspondingly record positioning trajectory data of a positioning sensor and data of a motor encoder, and send the same to the processing unit; and
the processing unit, configured to deduce ideal trajectory information of the mobile robot by the data of the motor encoder in combination with a kinematic model of the mobile robot; and convert the positioning trajectory data into trajectory information of the mobile robot according to a mounting position of the positioning sensor, and then perform least squares problem solving after performing differential alignment with the ideal trajectory information to acquire calibrated kinematic parameters of the mobile robot and mounting parameters of the positioning sensor, thereby acquiring the calibrated kinematic parameters of the mobile robot and the mounting parameters of the positioning sensor.

15. A computer device, comprising a memory and a processor, the memory storing a computer program, wherein when executing the computer program, the processor implements the steps of the method according to claim 2.

16. A computer device, comprising a memory and a processor, the memory storing a computer program, wherein when executing the computer program, the processor implements the steps of the method according to claim 3.

17. A computer device, comprising a memory and a processor, the memory storing a computer program, wherein when executing the computer program, the processor implements the steps of the method according to claim 4.

18. A computer device, comprising a memory and a processor, the memory storing a computer program, wherein when executing the computer program, the processor implements the steps of the method according to claim 5.

19. A computer device, comprising a memory and a processor, the memory storing a computer program, wherein when executing the computer program, the processor implements the steps of the method according to claim 6.

20. A computer-readable storage medium, storing a computer program, wherein when executed by a processor, the computer program implements the steps of the method according to claim 2.
